(19) United States
(12) Patent Application Publication
(10) Pub. No.: US 2026/0229052 A1
(43) Pub. Date: Aug. 6, 2026

(54) SYSTEM AND METHOD TO EXTRACT, ANNOTATE, AND EXPLOIT A DESCRIPTIVE SCRIPT FROM VIDEO

(71) Applicant: SECURIPORT LLC, Reston, VA (US)

(72) Inventors: Marcelo MOTTA, Reston, VA (US); Nathan CARPENTER, Reston, VA (US); Enrique SEGURA, Reston, VA (US)

(21) Appl. No.: 19/531,404

(22) Filed: Feb. 5, 2026

Related U.S. Application Data
(60) Provisional application No. 63/754,457, filed on Feb. 5, 2025.

(51) Int. Cl. G06V 20/70; G06V 40/16; H04N 7/18

(52) U.S. Cl. CPC G06V 20/70; G06V 40/174; H04N 7/18

(57) ABSTRACT

The embodiments provide computer-based systems, devices, methods, and instructions that can extract, annotate, and utilize descriptive scripts from video sources in a structured and detailed manner. The embodiments integrate advanced video analytics to provide a comprehensive understanding of scene contexts, including the derivation of inferential data like emotions and inferred speech. The embodiments enable real-time alerts based on nuanced scene analysis and assist in operational decision-making about video storage prioritization.

This application claims the benefit of U.S. Provisional Patent Application No. 63/754,457, filed on February 5, 2025, which is hereby incorporated by reference in its entirety.

### FIELD OF THE INVENTION

The present invention relates to video data processing systems and more particularly to extracting, annotating, and utilizing descriptive or structured scripts from video sources.

### DISCUSSION OF THE RELATED ART

The field of video processing and analysis has seen significant advancements with the proliferation of video recording devices, ranging from consumer electronics to sophisticated surveillance systems. These devices generate vast amounts of video data that need to be processed, analyzed, and archived effectively. Traditionally, video analysis has relied heavily on manual oversight, requiring significant human resources to watch and interpret footage. This method is not only labor-intensive, but can also be prone to human error and bias, leading to inconsistencies and oversight in video content interpretation.

Technologies for video processing often focus on the simple extraction of visible data such as objects and basic movements, without the ability to comprehend or annotate the contextual significance of scenes. These systems are limited in their capacity to automatically provide detailed and structured descriptions of video content, which is crucial for applications such as security monitoring and forensic investigation. Moreover, many systems lack the capability to process videos without accompanying audio, reducing their utility in contexts like silent closed-circuit television (CCTV) footage. Current solutions do not effectively utilize the inferential analysis of non-obvious data such as emotions or inferred speech, leaving a gap in comprehensive video analytics.

The limitations are underscored in the area of real-time alert generation and storage management. Present systems typically offer basic functionality that deliver alerts based on simple motion detection or predefined triggers, without considering the complex, contextual nature of the scene. This can result in a high incidence of false positives or missed critical events, reducing the reliability of alerts during critical incidents. Additionally, the decision-making process for video data storage often lacks sophisticated analysis, leading to inefficient storage practices or the potential loss of valuable data.

### SUMMARY OF THE INVENTION

Accordingly, the present invention is directed to computer-based systems, devices, methods, and instructions for extracting, annotating, and exploiting a descriptive script from video that substantially obviates one or more problems due to limitations and disadvantages of the related art.

One object of the technology is to improve the efficiency of video data management by enabling the generation of descriptive or structured scripts that support query and alert functions. Through this, users can perform searches based on specific criteria and receive alerts when those criteria are met, optimizing the utility and relevance of stored video data.

Another object of the technology is to support operational decision-making regarding video storage. By analyzing and annotating video content, the system helps prioritize which data should be preserved, based on the content's significance or relevance as determined according to predefined criteria.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The embodiments include systems, devices, methods, and instructions for extracting and utilizing descriptive scripts from video sources. The embodiments are configured to process both audio-bearing and silent videos, such as CCTV footage, through one or more video sources. The embodiments process the video data to generate a detailed, structured, and annotated representation of scenes, enabling applications such as real-time alerts and forensic analysis.

The system integrates several components, including an annotated video cache, video processing controller, and video analytics. These components collectively function to process video frames, annotate them, and store the resulting data in a descriptive or structured script. The fusion processor is tasked with integrating annotations into a coherent script, which is then maintained in a script and scene store, facilitating easy access and indexing.

The embodiments may include additional features such as a video management system for storing and managing video data, a script cache for temporary script element storage, and a script processing controller for managing script continuity. Script analytics may further enrich scene elements with detailed structural data, enhancing the utility of the scripts generated by the system.

In an example embodiment, an alert system is incorporated to issue real-time alerts based on video annotations. The technology also includes a display interface to facilitate user interaction with scripts and video, supporting playback and querying activities.

In another example embodiment, the techniques include processing both visual and inferred data, using indicators such as facial expressions and lip movements to infer non-obvious information like speech, language, and emotional states. This enhances the capability of the system to deliver actionable intelligence from the video content.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a system for extracting and utilizing descriptive scripts from video sources, comprising components such as video annotation and script generation engines.

FIG. 2 is a flowchart depicting a method for extracting and utilizing descriptive scripts from video sources, incorporating steps from receiving video frames to processing annotations and issuing alerts.

### DETAILED DESCRIPTION

Reference will now be made in detail to the embodiments of the present invention, examples of which are illustrated in the accompanying drawings.

The technology disclosed is situated in the field of video data processing systems, with a particular focus on extracting, annotating, and utilizing descriptive or structured scripts from video sources. It encompasses components such as video management, video analytics, script processing, and alert systems, applicable to contexts like real-time alerts, forensic analysis, and operational decision-making concerning video data storage.

The embodiments provide computer-based systems, devices, methods, and instructions that can extract, annotate, and utilize descriptive scripts from video sources in a structured and detailed manner. The embodiments integrate advanced video analytics to provide a comprehensive understanding of scene contexts, including the derivation of inferential data like emotions and inferred speech. The embodiments enable real-time alerts based on nuanced scene analysis and assist in operational decision-making about video storage prioritization. This approach addresses the shortcomings of existing technologies by offering a versatile solution applicable across multiple domains, enhancing security monitoring, forensic precision, and the efficiency of historical video analysis.

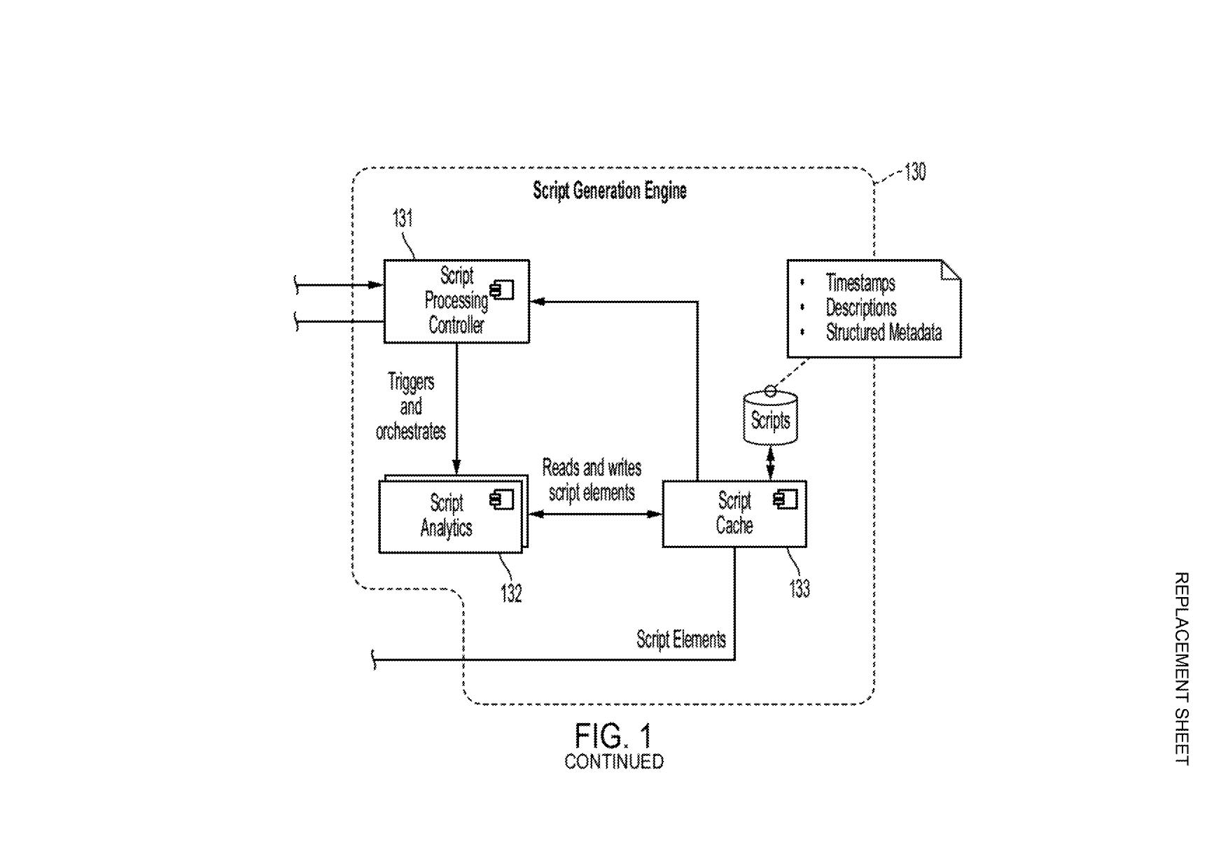

FIG. 1 shows a system architecture 100 for video processing and script generation.

Within video annotation engine 120 is an annotated video cache 121, video processing controller 122, and one or more modules (e.g., software) for video analytics 123. Annotated video cache 121 receives, annotates, and temporarily stores frames or sets of frames for processing (from one or more video sources 110). Video processing controller 122 retrieves annotated data from the annotated video cache 121, orchestrates its processing by the video analytics 123, and maintains scene context across processes. Video analytics 123 processes one or more frames to generate annotations and enrich the scene context.

Within script generation engine 130, a script processing controller 131 retrieves annotated data from annotated video cache 121, orchestrates its processing by the video analytics 123, and maintains script context across processes. Script cache 133 generates, annotates, and temporarily stores script elements for processing. One or more modules (e.g., software) for script analytics 132 process extracted scene elements and annotations along with existing script elements to enrich the script.

A fusion processor 141 assembles, aggregates, performs holistic analysis, and normalizes the video annotations and script elements into a final structured annotated script linked to the source video. A script and scene store 142 stores, manages, indexes, and allows query on final structured annotated scripts, entities, objects, and scenes. An optional video management system 143 stores and manage video data. One or more modules (e.g., software) for an alert system 144 monitor incoming data and issue alerts based on matching criteria from video annotations, script elements, entities, objects, and the final fused script. A display 145 that allows users to interact with scripts, alerts, and video.

System 100 includes video annotation engine 120 and a script generation engine 130, which together collaborate to process video streams of video sources 110 and generate scripts. The video annotation engine 120 begins by receiving video streams from one or more video sources 110. These video streams are directed to an annotated video cache 121 where video frames are annotated with timestamps (e.g., for synchronization of multiple video streams), entities, objects, activities, speech, sounds, and the like.

The video processing controller 122 triggers and orchestrates actions in video analytics 123, which reads and writes annotations back to annotated video cache 121. The annotated video streams, enriched with metadata, are further processed by fusion processor 141. Fusion processor 141 integrates video annotations, facilitating the generation of scripts.

Script generation engine 130 includes script processing controller 131 that interfaces with script analytics 132. Script analytics 132 component reads and writes script elements to a script cache 133. The script processing controller 131 sends results to fusion processor 141, which synthesizes video annotations and script elements into a structured format.

Following processing, the structured script is stored in script and scene store 142. The video management system 143, interacting with these scripts, enables querying and playback functionalities through display 145. The alert system 144 is available to issue and manage alerts, further enhancing the user experience. The video management system 143 manages video storage rules and queries, promoting effective data handling.

As illustrated in FIG. 1, system 100 may include a bus and/or other communication mechanism(s) configured to communicate information between the various components of system 100, such as one or more processors (e.g., video processing controller 122, script processing controller 131, fusion processor 141) and one or more memory devices (e.g., annotated video cache 121, script cache 133). In addition, a communication device may enable connectivity between a processor and other components by encoding data to be sent from processor to another component over a network and decoding data received from another system over the network for the processor.

For example, the communication device may include a network interface card that is configured to provide wireless network communications. A variety of wireless communication techniques may be used including infrared, radio, Bluetooth, Wi-Fi, and/or cellular communications. Alternatively, the communication device may be configured to provide wired network connection(s), such as an Ethernet connection.

The processor may comprise one or more general or specific purpose processors (e.g., graphic or video processor) to perform computation and control functions of system 100. The processor may include a single integrated circuit, such as a micro-processing device, or may include multiple integrated circuit devices and/or circuit boards working in cooperation to accomplish the functions of the processor.

System 100 may include one or more memory devices for storing information and instructions for execution by the various components (e.g., fusion processor 141). The memory may contain various components for retrieving, presenting, modifying, and storing data. For example, the memory may store software modules that provide functionality when executed by the processor. The software modules may include an operating system that provides operating system functionality for system 100. The software modules may further include artificial intelligence, self-learning, and various video and script analytics modules configured to execute the functionality described in connection with FIG. 1.

The one or more memory devices may include a variety of computer-readable media that may be accessed by the processor. For example, the memory may include any combination of random-access memory (“RAM”), dynamic RAM (“DRAM”), static RAM (“SRAM”), read only memory (“ROM”), flash memory, cache memory, and/or any other type of non-transitory or transitory computer-readable medium.

The one or more processors are further coupled via bus to display 145, such as a stationary display or touch screen. A keyboard and a cursor control device, such as a computer mouse, are further coupled to the communication device to enable a user to interface with system 100.

One or more databases may store one or more video related applications. The databases may store data in an integrated collection of logically-related records or files. The database may be an operational database, an analytical database, a data warehouse, a distributed database, an end-user database, an external database, a navigational database, an in-memory database, a document-oriented database, a real-time database, a relational database, an object-oriented database, or any other database known in the art.

Although shown as a single system 100, the components of FIG. 1 may be part hosted on a single device or a distributed system comprising multiple devices. Additionally, although multiple processing units are depicted, their respective functionality may be combined or separately implemented one or more processing units. Similarly, although multiple memory components are depicted, their respective functionality may be combined or separately implement one or more memory components.

In some embodiments, the system 100 incorporates a confidence scoring module that evaluates and ranks the reliability of annotations generated by the video analytics 123 and script analytics 132. The confidence scoring module (not shown) assigns a quantitative reliability score to each annotation based on the computational certainty of the underlying detection or inference. For example, when processing video frames, the system can distinguish between high-confidence annotations derived from objective visual data (such as detecting that a person is eating based on hand-to-mouth movements and the presence of food items) versus low-confidence annotations that require subjective interpretation (such as inferring emotional states like happiness from facial expressions). While eating behaviors produce characteristic, observable patterns with measurable features (e.g., jaw movement, utensil detection, food object recognition), emotional state determinations are inherently more ambiguous—a slight smirk may indicate happiness, sarcasm, nervousness, or concealed distress. The confidence scoring module applies a reliability threshold to each annotation type, wherein annotations derived from direct visual observation of physical actions receive higher reliability scores (e.g., 0.85-0.95 on a normalized scale) while annotations requiring emotional or psychological inference receive lower scores (e.g., 0.40-0.65). When an analyst queries the script and scene store 142 for instances matching specific criteria - such as "person eating OR person happy" - the system returns results ranked by their associated confidence scores, enabling the analyst to prioritize review of high-confidence matches while flagging low-confidence annotations for manual verification. This reliability ranking may be visually presented through display 145 using color coding, numerical scores, or confidence bands, and may be adjustable based on user-defined thresholds for different operational contexts such as real-time alerting (which may require higher confidence thresholds) versus forensic analysis (which may include lower-confidence matches for comprehensive review).

The terms 'structured script' and 'descriptive script' are used interchangeably herein to refer to a machine-readable, annotated representation of video content comprising timestamped entities, objects, actions, and/or inferred data organized in a structured format such as JSON, XML, or relational database schema. In some instances, the system generates both a descriptive script and a structured script. The descriptive script comprises natural language narratives describing scene contents, actions, and events in a human-readable format suitable for display and review. The structured script comprises the same information encoded in a machine-readable format (such as JSON, XML, or relational database records) with explicit data fields for entities, timestamps, positions, annotations, and confidence scores, enabling automated querying and processing. The fusion processor 141 generates both representations simultaneously, storing the structured script in script and scene store 142 for querying while making the descriptive script available through display 145 for human review.

In some embodiments, the descriptive or structured script (or structured descriptive script) can be formatted as a JSON object, for example, comprising timestamped scene segments, each segment containing arrays of detected entities with associated position coordinates, identified actions with confidence scores, and inferred data such as emotional states or speech content. For example, a scene segment may include entity objects specifying entity_id, type (person/vehicle/object), position coordinates (x,y), detected actions (e.g., 'eating', 'entering', 'speaking'), and inferred attributes (e.g., emotional_state: 'happy', confidence: 0.58). In another embodiment, the structured script is stored in a relational database schema with linked tables for scenes, entities, annotations, and confidence scores, enabling complex queries across multiple video sources. The structured format enables automated querying by criteria such as 'all scenes where entity type=person AND action=eating AND confidence>0.85'.

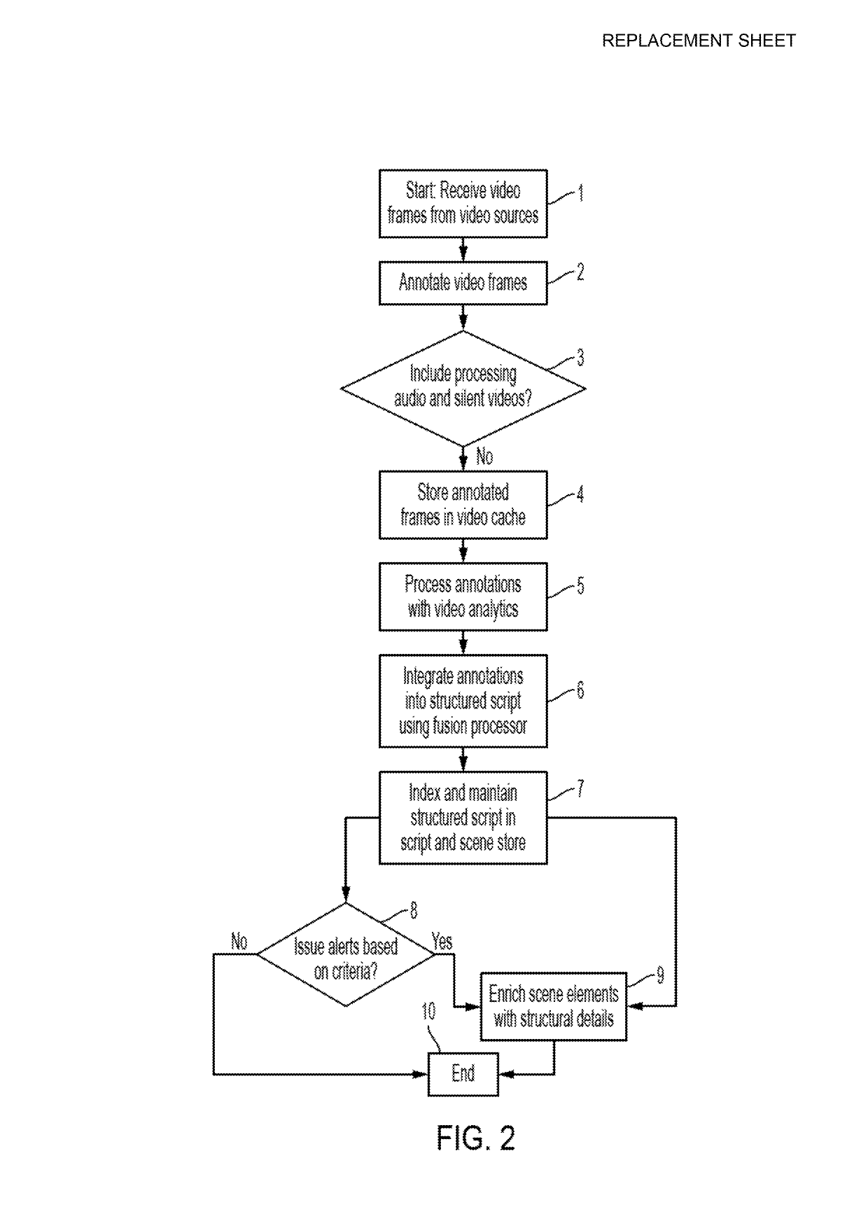

Turning to FIG. 2, the figure depicts a flowchart illustrating the process flow of video annotation and script generation. At step 1, video frames are received from video sources, initiating the process. Step 2 involves annotating these video frames, which may include information such as timestamps and objects.

Step 3 assesses whether to include audio and silent video processing. If affirmative, the processing continues to step 4, where annotated frames are stored in a video cache. At step 5, annotations are processed through video analytics, enhancing the metadata.

Step 6 involves the integration of annotations into a structured script using the fusion processor. This integration supports the organization and structuring of data, which is then indexed and maintained in a script and scene store during step 7.

Step 8 determines whether alerts should be issued based on predefined criteria. Should alerts be necessary, step 9 enriches scene elements with structural details to contextualize alerts. Finally, step 10 marks the conclusion of the process flow, ensuring that all elements are appropriately processed and stored.

In the various embodiments, the predefined criteria may be configured by a system administrator or analyst and can include entity-based criteria (e.g., person enters restricted area, vehicle type matches specified class, number of persons in frame exceeds threshold), action-based criteria (e.g., person running, object left unattended for duration exceeding a threshold, hand-to-hand exchange detected, fall detected), temporal criteria (e.g., activity occurring outside specified hours, entity appearing at multiple locations within a time window, repeated entries by same entity), behavioral criteria (e.g., emotional state matching a specified value with confidence exceeding a threshold, aggressive behavior indicators, inferred speech containing specified keywords), object interaction criteria (e.g., person touching specified object type, person eating in prohibited area), composite Boolean criteria combining multiple conditions using logical operators (e.g., person enters restricted area AND time is after hours AND no security badge detected), and storage prioritization criteria (e.g., scenes with confidence scores below threshold are eligible for compression, scenes matching security-relevant patterns are flagged for permanent preservation). The criteria are evaluated against annotations and structured scripts stored in script and scene store 142, with matching results triggering automated actions by alert system 144 or informing retention decisions by video management system 143. The embodiments are not limited to the foregoing examples. The foregoing are also examples of extracted scene elements with structural details.

Thus, the embodiments generate a descriptive script from audio-bearing or silent video (from CCTV or other source) containing one or more people and objects by extracting and annotating features, including but not limited to speech (through videp facial or lip analysis), language identification, speaker identification, body language, facial expressions, emotions, scene contents, and descriptive positions of people and objects. The script can be used in real-time to generate alerts, used forensically to search the video data, and used operationally to decide what video should be preserved long-term.

The embodiments process and analyze video to generate a descriptive and time-stamped structured representation of a scene, provide for alerting observers when combinations of entities, objects, and events occur, and provide the capability to query a scene or scenes to locate and correlate information. This functions on a video with or without audio, using techniques to infer sound and speech from analysis of the video.

In other words, the embodiments build a “script” from a CCTV feed or other video - in concept, similar to a screenplay which describes the scene, the actions, and the dialogue. The embodiments produce such a description with enhancements for automated processing such as timestamps, structured information, and annotations. Scripts from all feeds are processed and stored, and entities and objects within correlated, to enable observers to query for entities, objects, scenes, and descriptions matching certain criteria, or to be alerted when certain criteria are met. Criteria are configured against this information to mark frames for preservation during compression or video deletion to keep important data safe from removal.

The structured representation may include but is not limited to: the types and identities (if applicable) of entities and objects in the scene; the relative and absolute locations of entities and objects in the scene; the actions performed on or by entities and objects in the scene (e.g., entering, exiting, interacting with other entities and objects); states of entities within the scene (e.g., emotional states, poses, body language, micro-expressions); textual descriptions or re-creations of sounds, including but not limited to speech, that can be extracted; explicit metadata, such as the location and orientation of the camera; and inferred metadata, such as language identification of the speech being uttered.

The embodiments are readily applicable to a variety of arenas. There are many sources of video without audio; for example, from security cameras used in CCTV systems. In an actively monitored environment such as a border point or secure area, the observer is limited to what they can see - they can’t tell what is being said. Likewise in a forensic situation, the observer needs to go through the entire video to analyze a past event. Analyzing and annotating this video as it is taken could provide alerts to the monitoring individuals to prevent or mitigate an event, and having this data in a searchable format will allow operators to quickly find important or relevant people, objects, or activities. In addition, since video storage is expensive, yet preservation of important scenes is vital to investigation, this data can be used to prioritize which video to compress or remove from the system and which to keep.

The embodiments are readily applicable to numerous other applications, such as analytics on interviews; auto CC enhancement for videos or video calls; CCTV for live or historical feeds; and forensics and investigation based on any video feed.

It will be apparent to those skilled in the art that various modifications and variations can be made in the computer-based systems, devices, methods, and instructions for extracting, annotating, and exploiting a descriptive script from video of the present invention without departing from the spirit or scope of the invention. Thus, it is intended that the present invention covers the modifications and variations of this invention provided they come within the scope of the appended claims and their equivalents.

What is claimed is:

1. A system for extracting and utilizing descriptive scripts from video sources, comprising:
one or more video sources;
an annotated video cache configured to receive and store frames from the video sources;
a video processing controller operatively connected to the annotated video cache and configured to retrieve and process annotated data;
video analytics configured to process frames to generate annotations;
a fusion processor configured to integrate the annotations into a structured script; and
a script and scene store configured to maintain and index the resulting structured scripts.

2. The system of claim 1, further comprising a video management system configured to store and manage video data.

3. The system of claim 1, wherein the video sources include audio-bearing and silent videos.

4. The system of claim 1, further comprising a script cache for generating and temporarily storing script elements.

5. The system of claim 1, further comprising a script processing controller configured to manage script elements.

6. The system of claim 1, further comprising script analytics configured to enrich extracted scene elements with structural details.

7. The system of claim 1, further comprising an alert system for issuing alerts based on predefined criteria related to annotations.

8. The system of claim 1, further comprising a display interface for user interaction with scripts and video.

9. The system of claim 1, further comprising a confidence scoring module configured to assign reliability scores to annotations and rank annotations based on their assigned reliability scores when responding to queries.

10. A method for extracting and utilizing descriptive scripts from video sources, comprising:
receiving video frames from one or more video sources;
annotating the video frames and storing them in an annotated video cache;
processing the annotations with video analytics;
integrating the annotations into a structured script using a fusion processor; and
maintaining and indexing the structured script in a script and scene store.

11. The method of claim 10, further comprising issuing alerts based on predefined criteria set against the video annotations.

12. The method of claim 10, further comprising enriching extracted scene elements with structural details through script analytics.

13. The method of claim 10, wherein annotating video frames includes processing audio and silent videos.

14. A system for analyzing video and issuing alerts, comprising:
one or more video sources;
video analytics configured to annotate frames from the video sources; and
an alert system configured to monitor annotations and issue alerts based on predefined criteria.

15. The system of claim 14, further comprising a display interface for facilitating interaction with the video and alerts.

16. The system of claim 14, wherein the video sources include closed-circuit television (CCTV) footage.

17. A method for performing inferential data extraction from video, comprising:
processing video frames to analyze visual data;
inferring non-obvious data from visual indicators including one or more facial expressions or lip movements; and
integrating inferred data into a structured script for further analysis.

18. The method of claim 17, wherein the inferred data includes speech and language information.

19. The method of claim 17, wherein the inferred data includes emotional state assessments.

20. The method of claim 17, further comprising the step of utilizing the structured script for operational decision-making regarding video storage.
